(19) United States
(12) Patent Application Publication
(10) Pub. No.: US 2022/0103942 A1
(43) Pub. Date: Mar. 31, 2022

(54) SOUND PLAYBACK METHOD

(71) Applicant: SAGEMCOM BROADBAND SAS, RUEIL MALMAISON (FR)

(72) Inventors: Gabriel BOUVIGNE, RUEIL MALMAISON (FR); Olivier MEVISSEN, RUEIL MALMAISON (FR)

(21) Appl. No.: 17/489,247

(22) Filed: Sep. 29, 2021

(30) Foreign Application Priority Data
Sep. 30, 2020 (FR) 2009961

(51) Int. Cl. H04R 3/12; G06F 3/16; G10L 19/16; G10L 19/22; H04R 27/00; H04N 21/439

(52) U.S. Cl. CPC H04R 3/12; G06F 3/165; G10L 19/167; H04R 2227/005; H04R 27/00; H04N 21/439; G10L 19/22

(57) ABSTRACT

A sound playback method implemented in a system including an audio/video decoder and a plurality of pieces of audio playback equipment that have been grouped together in the same audio group, the method comprising the steps of defining a first subgroup comprising the audio/video decoder and at least one first piece of audio playback equipment, and a second subgroup comprising at least one second piece of audio playback equipment; dynamically determining a current mode that is occupied by the system; when the system is in the first mode, causing the first subgroup to play back a first audio signal comprising a common audio content, and causing the second subgroup to play back a second audio signal comprising the common audio content; when the system is in the second mode, causing the first subgroup to play back a third audio signal comprising an audio stream forming part of the audio-video stream, and causing the second subgroup to play back a fourth audio signal.

The invention relates to the field of systems comprising an audio/video decoder and a plurality of smart speakers, and in particular systems for providing “multiroom” audio.

### BACKGROUND OF THE INVENTION

Certain recent smart speakers can be associated with one another and configured to form an audio system that offers novel functions. By way of example, these functions include the multiroom function, which serves to define different audio groups (or zones), each having one or more smart speakers, and to synchronize sound playback between the various audio groups.

Within such a system, there may be one or more speaker enclosures that are more particularly intended for playing back sound that is normally associated with a television set, in order to improve the quality of audio rendering. By way of example, such a speaker enclosure may be of the “soundbar” type, i.e. a multi-channel enclosure of elongate shape and low height for placing in front of the television set.

The soundbar is usually connected via an HDMI link to the television set or to the digital audio decoder (which is often incorporated in a decoder unit or “set-top box”).

The users of such an audio system frequently complain about the following problem.

The soundbar connected to the television set may either be in a “music rendering” configuration, in which it plays back music content (e.g. content delivered by streaming from a smartphone or a tablet), or else it may be in a “TV rendering” configuration, in which it plays back an audio stream that is associated with a video stream that is being played back by the television set.

When the soundbar is in its music rendering configuration and a signal is detected on the HDMI input of the soundbar, the soundbar must switch from its music rendering configuration to its TV rendering configuration.

Two solutions exist in the prior art for managing this transition between the configurations.

A first solution consists in defining a priority level between the audio inputs of the soundbar, with the HDMI input then potentially having higher priority.

The drawback of this first solution is that, at the time of the transition, the television sound replaces the music content not only in the room where the television and the soundbar are situated (e.g. the living room), but also in the other rooms forming part of the same audio group (e.g. in the kitchen). A user situated in the kitchen can then no longer enjoy the music content.

A second solution consists in automatically “detaching” the soundbar from the audio group when an audio signal is detected on the HDMI input.

The drawback of this second solution is that once the audio-video stream is no longer being streamed, the soundbar no longer delivers music. The user is thus constrained to re-include the soundbar manually in the audio group. Furthermore, this “detaching” takes place as soon as an audio signal is detected on the HDMI input, including when the user is not viewing an audio-video stream such as a film, and for example when the user switches ON the audio/video decoder in order to browse through the graphics interface for the purpose of programming a recording.

As a result, neither of those approaches is fully satisfactory for users.

### OBJECT OF THE INVENTION

An object of the invention is to mitigate the drawbacks of the above-described solutions.

### SUMMARY OF THE INVENTION

In order to achieve this object, there is provided a sound playback method implemented in a system comprising an audio/video decoder connected to a television set and a plurality of pieces of audio playback equipment that have been grouped together in the same audio group, the method comprising the steps of:
defining a first subgroup comprising the audio/video decoder and at least one first piece of audio playback equipment, and a second subgroup comprising at least one second piece of audio playback equipment;
as a function of at least one predefined parameter comprising a current operating state of the audio/video decoder, dynamically determining a current mode that is occupied by the system, from among a plurality of predefined modes comprising a first mode and a second mode;
when the system is in the first mode, in which the audio/video decoder is not delivering an audio-video stream, causing the first subgroup to play back a first audio signal comprising a common audio content, and causing the second subgroup to play back a second audio signal comprising the common audio content;
when the system is in the second mode, in which the audio/video decoder is delivering an audio-video stream, causing the first subgroup to play back a third audio signal comprising an audio stream forming part of the audio-video stream, and causing the second subgroup to play back a fourth audio signal.

In the sound playback method of the invention, there are thus defined first and second subgroups of pieces of audio playback equipment, both subgroups forming parts of the audio group. The audio signals played back by the first subgroup and by the second subgroup may potentially be different, and they depend on the current operating state of the audio/video decoder. It is thus possible, without modifying the composition of the audio group, to cause a music content to be played back by the entire audio group, and then to start playing back an audio-video stream (e.g. a film) via the television set and the first subgroup without interrupting the playback of the music content by the second subgroup.

There is also provided a sound playback method as described above, wherein the fourth audio signal does not comprise the audio stream forming part of the audio-video stream.

There is also provided a sound playback method as described above, wherein the fourth audio signal comprises the audio stream forming part of the audio-video stream.

There is also provided a sound playback method as described above, further comprising the step of determining that the system switches from the first mode to the second mode when the audio/video decoder switches from an operating state in which it is not delivering an audio-video stream to an operating state in which it is delivering an audio-video stream.

There is also provided a sound playback method as described above, wherein, when the system is in the first mode (or respectively in the second mode) and when a user is browsing in a graphical interface of the audio/video decoder visible on the television set, the first audio signal (or respectively the third audio signal) comprises sounds associated with browsing in said graphical interface, and the second audio signal (or respectively the fourth audio signal) does not comprise the sounds associated with browsing in said graphical interface.

There is also provided a sound playback method as described above, wherein the plurality of predefined modes also comprises a first submode and a second submode forming parts of the first mode, the system switching from the first submode to the second submode when the audio/video decoder switches from an active state in which the audio/video decoder can deliver a video content to a first standby state in which the audio/video decoder cannot deliver video content, and switches from the second submode to the first submode when the audio/video decoder switches from the first standby state to the active state.

There is also provided a sound playback method as described above, wherein the audio/video decoder includes an internal speaker that is in an ON state when the audio/video decoder is in the first standby state, and wherein the plurality of predefined modes also comprises a third submode forming part of the first mode, the system switching from the second submode to the third submode when the audio/video decoder switches from the first standby state to an OFF state or to a second standby state in which the internal speaker is in an OFF state, and switching from the third submode to the second submode when the audio/video decoder switches from the OFF state or from the second standby state to the first standby state.

There is also provided a sound playback method as described above, further comprising the step of preventing the audio/video decoder from switching to the second standby state while the system is in the first mode and the common audio content is being played back.

There is also provided a sound playback method as described above, wherein the plurality of predefined modes also comprises a third mode, the system switching from the third submode to the third mode when all of the second pieces of audio playback equipment switch to an OFF state, and from the third mode to the first mode when the audio/video decoder switches to an ON state and/or at least one of the second pieces of audio playback equipment switches to an ON state.

There is also provided a sound playback method as described above, comprising the step of not allowing the audio group to contain more than one audio/video decoder.

There is also provided a system comprising an audio/video decoder and a plurality of pieces of audio playback equipment grouped together in the same audio group, wherein the system implements the sound playback method as described above.

There is also provided a computer program including instructions for causing the above-described system to execute the steps of the above-described sound playback method.

There is also provided a computer-readable storage medium, having stored thereon the above-described computer program.

There is also provided master equipment forming part of a system comprising an audio/video decoder and a plurality of pieces of audio playback equipment grouped together in the same audio group, the master equipment being arranged to implement the above-described sound playback method.

There is also provided master equipment as described above, the master equipment being an audio/video decoder.

There is also provided master equipment as described above, the master equipment being a smart speaker.

There is also provided a computer program including instructions for causing the above-described master equipment to execute the steps of the above-described sound playback method.

There is also provided a computer-readable storage medium, having stored thereon the above-described computer program.

The invention can be better understood in the light of the following description of a particular, nonlimiting implementation of the invention.

### BRIEF DESCRIPTION OF THE DRAWINGS

Reference is made to the accompanying drawings, in which:

FIG. 1 shows a first room and a second room in a user's home;

FIG. 2 shows the first subgroup and the second subgroup of the audio group;

FIG. 3 is a table listing the various operating states of the audio/video decoder and of the pieces of audio playback equipment in the various modes of the system;

FIG. 4 shows the transitions between the various modes of the system;

FIG. 5 is a flowchart representing a first functional arrangement of the system, which is in the third submode of the first mode;

FIG. 6 is a flowchart representing a second functional arrangement of the system, which is in the second submode of the first mode;

FIG. 7 is a flowchart representing a third functional arrangement of the system, which is in the first submode of the first mode;

FIG. 8 is a flowchart representing a fourth functional arrangement of the system, which is in the first mode (and which is configured in the first configuration);

FIG. 9 is a flowchart representing a fifth functional arrangement of the system, which is in the first mode (and which is configured in the second configuration);

FIG. 10 shows an audio group having two decoder units.

### DETAILED DESCRIPTION OF THE INVENTION

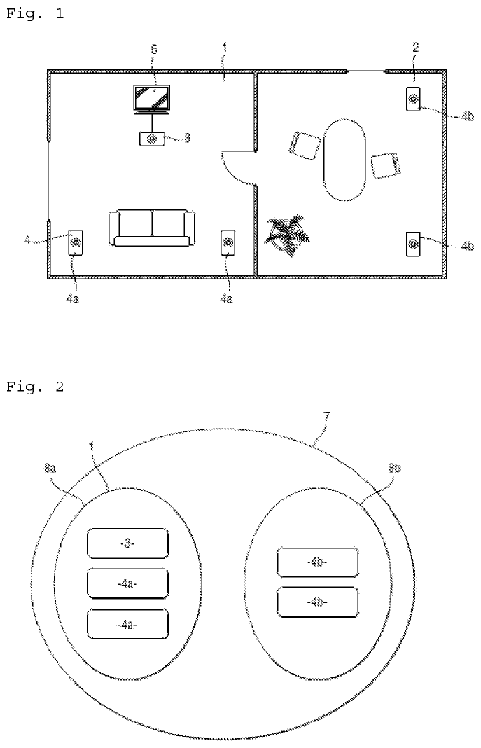

With reference to FIG. 1, a user's home has a first room 1 and a second room 2.

An audio/video decoder 3 and pieces of audio playback equipment, specifically two smart speakers 4a, are positioned in the first room 1.

The audio/video decoder 3 may itself have loudspeakers incorporated therein: the term “internal speaker” is used to refer to this audio playback device incorporated in the audio/video decoder 3. The audio/video decoder 3 is connected to the television set 5 by an HDMI link, and to the smart speakers 4a by any suitable wired or wireless link.

The audio/video decoder in this example is a decoder unit (or “set-top box”), but it could be incorporated in the television set, although it could be situated in an appliance that provides other functions (e.g. a game console).

In this example, the smart speakers 4a are intended mainly to provide sound extension memes when the television set is playing back video, e.g. as speakers paying back the rear channels of a multi-channel configuration.

Two other pieces of audio playback equipment, specifically two smart speakers 4b, are positioned in the second room 2.

The audio/video decoder 3 and the smart speakers 4 form a system in which the multiroom function is implemented.

Instead of being based on HDMI negotiation for automatically giving priority to the audio stream of an audio-video stream delivered by the audio/video decoder 3 (as in the prior art solutions), the invention is based on the audio/video decoder 3 cooperating with the smart speakers 4 in order to allow the system to switch between a plurality of possible modes.

The sound playback method of the invention can be implemented by master equipment present in a local area network (LAN) or in a wide area network (WAN). The master equipment may be the audio/video decoder 3, or one of the smart speakers 4, or indeed one or more remote pieces of equipment (e.g. one or more servers).

The system may also be operated in “peer-to-peer” mode, which means that the sound playback method of the invention is implemented by the pieces of equipment of the system acting together.

The messages needed to enable the system to operate may be sent over the LAN (in unicast or multicast mode), or via the WAN (in particular if the multiroom system relies on control performed by a remote server/system).

Messages may be exchanged using various protocols. A nonlimiting list of such protocols is as follows.

By way of example, for unicast LAN, the protocols may be the following: simple object access protocol (SOAP) over hypertext transfer protocol (HTTP) or simple mail transfer protocol (SMTP), common object request broker architecture (CORBA), distributed component object model (DCOM), JavaScript object notation—remote procedure call (JSON-RPC).

By way of example, for multicast LAN, the protocols may be the following: universal plug and play (UpnP), general event notification architecture (GENA). By way of example, for WAN, the protocols may be the following: JSON sent over a transmission control protocol (TCP) socket or a user datagram protocol (UDP) socket, SOAP sent over a UDP socket.

When the sound playback method of the invention is implemented by master equipment, its various steps are performed in a processor module of said master equipment, which module comprises a processor component adapted to execute instructions of a program for performing the sound playback method. By way of example, the processor component may be a processor, a digital signal processor (DSP), a microcontroller, or indeed a programmable logic circuit such as a field programmable gate array (FPGA) or an application-specific integrated circuit (ASIC). If the sound playback method is implemented by a plurality of pieces of equipment acting together, then its various steps are performed by the various processor modules of said pieces of equipment.

The audio/video decoder 3 is always in a current operating state, which may be any one of a plurality of predefined operating states. The predefined operating states comprise an OFF state and an ON state, which itself comprises a first active state, a second active state, a first standby state, and a second standby state.

In the first active state, the audio/video decoder 3 delivers an audio-video stream via the television set 5 (for the video stream), via its internal speaker (if there is one) and via some or all of the smart speakers 4 (for the audio stream). In the first active state, the user can also browse in the graphical interface screens of the audio/video decoder 3 (program schedule, messaging, programming recordings, Internet browser, etc.). The audio/video decoder 3 can play back sound associated with browsing in the graphical interface (e.g. the sounds used for the auditory feedback function). The sounds associated with browsing in the graphical interface may be superposed on the audio stream delivered by the audio/video decoder 3.

In the second active state, the audio/video decoder 3 does not deliver an audio-video stream but may be used by a user for browsing in the graphical interface, which is then visible on the television set 5. The user can browse in the screens of the graphical interface without any audio-video stream being delivered (or optionally, as an implementation selection or as a setting selected by the user, without video content being delivered in the foreground). Under such circumstances, the audio/video decoder 3 does not play back the audio stream associated with a video stream, but may play back sounds associated with browsing in the graphical interface. The audio/video decoder 3 may also play back audio content via its internal speaker (if any).

In the first standby state, sometimes referred to as “shallow” standby, the video outputs of the audio/video decoder 3 are switched OFF, the tuners are optionally put on standby, but the processor module is still active and the network interfaces are operating. Potentially, the audio outputs may be kept active for music delivery functions. It is thus considered that the internal speaker is ON and can play back audio content, e.g. music content.

In the second standby state, sometimes referred to as “deep” standby, the audio-video outputs are OFF, and the tuners and the processor module are either stopped or else placed in specific suspended/deep standby states. The processing capabilities of the audio/video decoder 3 are no longer accessible. The network interfaces are OFF. All that remains are means making it possible to leave this deep standby state. It is thus considered that the internal speaker is “OFF” and cannot play back audio content.

The audio/video decoder 3 passes temporarily through a shallow standby stage prior to passing into the deep standby state.

In this example, it is thus considered that the internal speaker may be in an ON state, in which it can play back audio content, or else in an OFF state.

However, the smart speakers 4 may either be in an ON state, or in a standby state, or else in an OFF state.

With reference to FIG. 2, the audio/video decoder 3 (including the internal speaker) and the smart speakers 4 have all been grouped together in the same audio group 7 prior to implementing the sound playback method. The audio group 7 may be defined either by a user (e.g. via a smartphone), or else automatically, or indeed it may be a group by default.

This grouping makes it possible to arrange for synchronized delivery of audio contents via all of the speakers 4 of the group 7. The user can thus listen to an audio content continuously even when moving between the two rooms, which audio content may come from an audio-video stream delivered by the audio/video decoder 3 (e.g. a film), or indeed by way of example, it may be music content delivered by a smartphone via the smart speakers 4 (and possibly also by the internal speaker of the audio/video decoder 3).

Other multiroom groups may optionally also be present in the user's home.

The sound playback method consists initially in grouping the audio/video decoder 3 (and thus its internal speaker) together with the smart speakers 4a in a first subgroup 8a and the smart speakers 4b together with one another in a second subgroup 8b.

It is the existence of these two subgroups 8 within the same multiroom audio group 7 that makes it possible to manage sound playback situations in a manner that is satisfying for the user.

The system as a whole is always in a current mode, which may be any one of a plurality of predefined modes comprising a first mode, a second mode, and a third mode. The method thus consists in determining the current mode, i.e. the mode that is currently occupied by the system, and in causing the first subgroup 8a and the second subgroup 8b to play back the audio signals that depend on the current mode.

The system is in the first mode when the following two conditions are satisfied: the audio/video decoder 3 is not delivering an audio-video stream (and in particular is not delivering a video stream via the television set 5), and at least one of the speakers from among the internal speaker and the smart speakers 4 is not OFF.

In the first mode, the first subgroup 8a may play back a first audio signal comprising a common audio content that does not belong to an audio-video stream, and the second subgroup 8b may play back a second audio signal comprising the common audio content.

By way of example, the common audio content may be music content. The entire system may thus play back the same music content, which may be delivered by various different means: an application on a smartphone or a tablet, software on a computer, a website capable of delivery via the “cloud”, physical buttons on the speakers, a dedicated controller or remote control, etc. It should be observed that even while no audio is being delivered, it is still considered that the system is in this first mode when the conditions are satisfied.

It should be observed that the first audio signal need not necessarily contain solely the common audio content.

Specifically, while the current mode of the system is the first mode, the audio/video decoder 3 may be used for browsing in its graphical interface, in which event the sounds associated with browsing in the graphical interface are played back by the first subgroup 8a belonging to the first room 1 in superposition on the common audio content (e.g. music content). The user thus continues to enjoy the music content, while benefiting from functions of the auditory feedback type. In comparison with existing systems, which interrupt delivery of music as soon as the HDMI link is switched ON, this constitutes a significant advantage for the user.

The two audio contents are preferably superposed by means of the audio mixing capabilities of the audio/video decoder 3. Alternatively, and in particular if the audio/video decoder 3 does not have such capabilities, provision may be made for the internal speaker of the audio/video decoder 3 and/or the external speakers 4a to play back the music content, while the sounds for the graphical interface are directed to the HDMI output so as to be played back by the internal speakers of the television set 5. In another alternative, it is also possible to ignore the sounds of the graphical interface completely (either because they cannot be played back, or else as a user preference). In yet another alternative, the audio/video decoder 3 may send the graphical interface sounds to the smart speakers 4a, and the smart speakers 4a may use their own mixing capabilities (if they have them) for superposing the music content and the graphical interface sound so as to produce the first audio signal.

The first mode has three submodes: a first submode, a second submode, and a third submode.

When the current mode of the system is the first submode, the audio/video decoder 3 is in the second active state: the user can browse in the graphical interface, the first subgroup 8a can play back both the music content and the sounds associated with browsing in the graphical interface, and the second subgroup 8b can play back the music content.

In the second submode, the audio/video decoder 3 is in the first active state. The first subgroup 8a and the second subgroup 8b can both play back the music content.

In the third submode, the audio/video decoder 3 is in an OFF state or in the second standby state. The first subgroup 8a (with the exception of the internal speaker) and the second subgroup 8b can both play back the music content.

When the current mode of the system is the second submode, the first subgroup 8a can play back a third audio signal comprising an audio stream belonging to an audio-video stream delivered by the audio/video decoder 3, and the second subgroup 8b can play back a fourth audio signal, which may potentially be different from the third audio signal.

The system enters into the second mode when the audio/video decoder 3 starts delivering an audio-video stream (live TV channel, video on demand (VOD), playback of a personal video recorder (PVR) recording, etc.). The audio/video decoder 3 is then in the first active state.

In this example, provision is made for the system to have two possible configurations when it is in the second mode. The first and second configurations of the system in the second mode are mutually exclusive: only one of the configurations is used.

These two configurations correspond to different behaviors for the same input condition (delivery of an audio-video stream). It is either the equipment supplier, or else the user (e.g. by means of a settings menu) who decides to use one or the other of the configurations.

If both configurations are made available by the manufacturer, then there must be a user setting to enable the user to select which configuration to be applied.

When the system is configured in the first configuration (and is in the second mode), the fourth audio signal does not comprise the audio stream from the audio-video stream delivered by the audio/video decoder 3.

Thus, the internal speaker and the smart speakers 4a of the first subgroup 8a play back the audio content for the television set 5, i.e. the audio stream of the audio-video stream, possibly together with the sounds associated with browsing in the graphical interface. Simultaneously, the smart speakers 4b of the second subgroup 8b are adapted to playing back a music content and not the audio stream. Users situated in the second room 2 can thus continue to enjoy the music content (if music content was being played back by the audio group 7 before starting delivery of the audio-video stream), or indeed can start listening to music content.

When the system is configured in the second configuration (and is in the second mode), the fourth audio signal comprises the audio stream from the audio-video stream as delivered by the audio/video decoder 3.

The internal speaker of the audio/video decoder 3 and the smart speakers 4a of the first subgroup 8a play back the audio content for the television set 5, i.e. the audio stream of the audio-video stream, together with the sounds associated with browsing in the graphical interface.

The smart speakers 4b of the second subgroup 8b also play back the audio stream of the audio-video stream, thereby enabling a user moving from the first room 1 to the second room 2 to continue to follow the sound portion of the television program. The sounds associated with browsing in the graphical interface are not played back in the second subgroup 8b, since in general they are useful only in association with browsing in the graphical interface (and are thus of no use in the second room 2).

It should be observed that it is possible to play back a multi-channel television audio content in the second room 2 (by adapting audio dematrixing to the number of speakers), but multi-channel configurations are of little interest when the image is not visible. Consequently, it seems more appropriate to play back the audio content for the television set 5 monophonically in the second room 2.

Finally, the system may be in a third mode. In the third mode, the internal speaker of the audio/video decoder 3 is OFF, as are all of the smart speakers 4a of the first subgroup 8a and of the second subgroup 8b.

In the third mode, no audio content is played back.

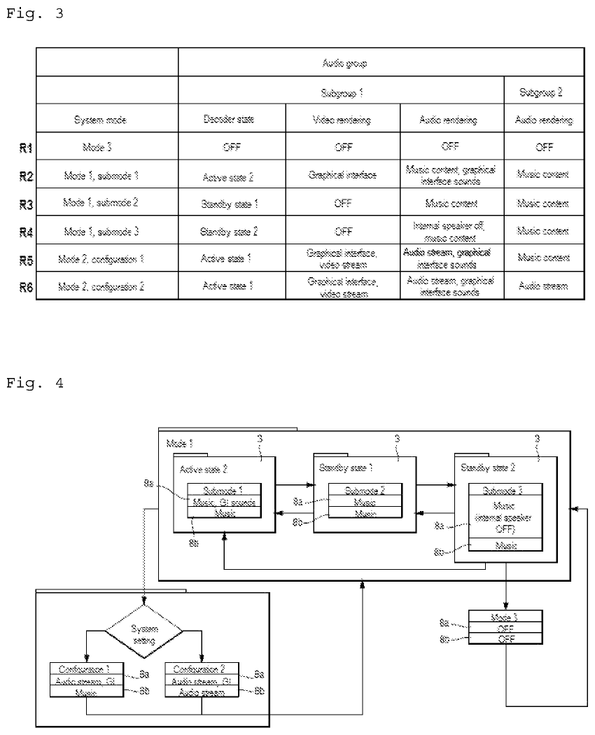

The above is summarized in the table of FIG. 3.

When the system is in the third mode, it can be seen that, the audio/video decoder 3 is in the OFF state (or in the second standby state), the video rendering and the audio rendering of the first subgroup 8a are both OFF, and the audio rendering of the second subgroup 8b is OFF (row R1).

When the system is in the first mode and the audio/video decoder 3 is in the second active state (first submode), the audio/video decoder 3 can play back the images of the capital interface, the first subgroup 8a can play back the common audio content (music content) and also the sounds of the graphical interface. The second subgroup 8b can play back the common audio content (row R2).

When the system is in the first mode and the audio/video decoder 3 is in the first standby state (second submode), video rendering is OFF, and the first subgroup 8a plays back the common audio content (music content) via the internal speaker of the audio/video decoder 3 and the smart speakers of the first subgroup 8a. The second subgroup 8b plays back the common audio content (row R3).

When the system is in the first mode and the audio/video decoder 3 is in the second standby state (third submode), video rendering is OFF, and the first subgroup 8a plays back the common audio content (music content) but only via the connected speakers 4a (since the internal speaker of the audio/video decoder 3 is OFF). The second subgroup 8b plays back the common audio content (row R4).

When the system is in the second mode, first configuration, the audio/video decoder 3 is in the first active state, the television set plays back the video stream associated with an audio-video stream being delivered by the audio/video decoder 3, optionally together with the images of the graphical interface. The first subgroup 8a plays back the audio stream of the audio-video stream, possibly together with the sounds of the graphical interface. The second subgroup 8b plays back a different audio content, e.g. a music content (row R5).

When the system is in the second mode, second configuration, the audio/video decoder 3 is in the first active state, the television set 5 plays back the video stream associated with an audio-video stream being delivered by the audio/video decoder 3, optionally together with the images of the graphical interface. The first subgroup 8a plays back the audio stream of the audio-video stream, possibly together with the sounds of the graphical interface. The second subgroup 8b also plays back the audio stream of the audio-video stream, but not the sounds of the graphical interface (row R6).

With reference to FIG. 4, there follows a description of the way in which transitions are triggered between the various modes of the system.

As mentioned above, implementing the sound playback method requires a current mode occupied by the system to be determined dynamically as a function of predefined parameters including the current operating states of the audio/video decoder 3 and of the smart speakers 4, which current mode is one of a plurality of predefined modes comprising a first mode (itself comprising a first submode, a second submode, and a third submode), a second mode, and a third mode.

The transitions between the modes are triggered by the occurrence of events relating to the operating states of the audio/video decoder 3, and of the smart speakers 4, and relating in particular to the changes of these operating states.

By way of example, consider the situation in which the system is occupying the first submode of the first mode.

That audio/video decoder 3 is in the second active state. The smart speakers 4a and the internal speaker of the first subgroup 8a can play back a common audio content, which is a music content, together with the sounds associated with browsing in the graphical application (GI sounds). The smart speakers 4b of the second subgroup 8b can play back the music content.

When the audio/video decoder 3 switches from the second active state to the first standby state, the system switches from the first submode to the second submode. The smart speakers 4a and the internal speaker play back solely the music content. The smart speakers 4b also play back the music content. Conversely, the system returns to the first submode when the audio/video decoder 3 switches from the first standby state to the second active state.

When the audio/video decoder 3 switches from the first standby state to an OFF state or to the second standby state, the system switches to the third submode. The internal speaker is in the OFF state. The smart speakers 4 play back the music content only. Conversely, the system returns to the second submode when the audio/video decoder 3 switches from the second standby state to the first standby state.

When the system is in the first mode and the audio/video decoder 3 starts delivering an audio-video stream, the system switches into the second mode, and more precisely either into the first configuration of the second mode or else into the second configuration of the second mode, depending on the settings of the system.

In the first configuration, the television set 5 plays back the video stream of the audio-video stream, the internal speaker and the smart speakers 4a play back the audio stream and sounds associated with browsing in the graphical interface, while the smart speakers 4b play back a music content.

In the second configuration, the television set 5 plays back the video stream, the internal speaker and the smart speakers 4a play back the audio stream and sounds associated with browsing in the graphical interface, while the smart speakers 4b play back the audio stream of the audio-video stream.

When the system is configured in the second mode and the audio-video stream stops being delivered, the system switches back to the first mode.

When the system is in the third submode of the first mode, the system switches to the third mode when all of the smart speakers 4b of the second subgroup 8b switch to the OFF state.

The system switches from the third mode to the first mode when the audio/video decoder 3 switches to an ON state (with the submode then depending on the ON state) and/or when at least one smart speaker 4b of the second subgroup 8b switches to an ON state.

There follows a description of a certain number of functional arrangements that serve to illustrate the operation of the invention.

With reference to FIG. 5, consider the situation in which the audio/video decoder 3 is in the second standby state. The system is in the first mode, third submode.

The system begins with selecting one of the smart speakers 4b forming part of the second subgroup 8b to act as master (step E1). By way of example, the smart speaker that is selected as master may be the speaker having the serial number that is the greatest. The master requests audio data containing a music content from a music streaming service (step E2), and the service responds by sending the audio data (step E3).

The master receives the audio data (step E4), decodes it, optionally proceeds with dematrixing the channels, followed optionally by rematrixing the channels (step E5), prior to sending the pertinent audio data to the various smart speakers 4 (step E6). The smart speakers 4a of the first subgroup 8a receive the audio data and decode it (step E7). Likewise, the smart speakers 4b of the second subgroup 8b receive the audio data and decode it (step E8). The smart speakers 4a of the first subgroup 8a (step E9), the master speaker (step E10), and the other smart speakers 4b of the second subgroup 8b (step E11) then proceed with synchronized delivery of the music content.

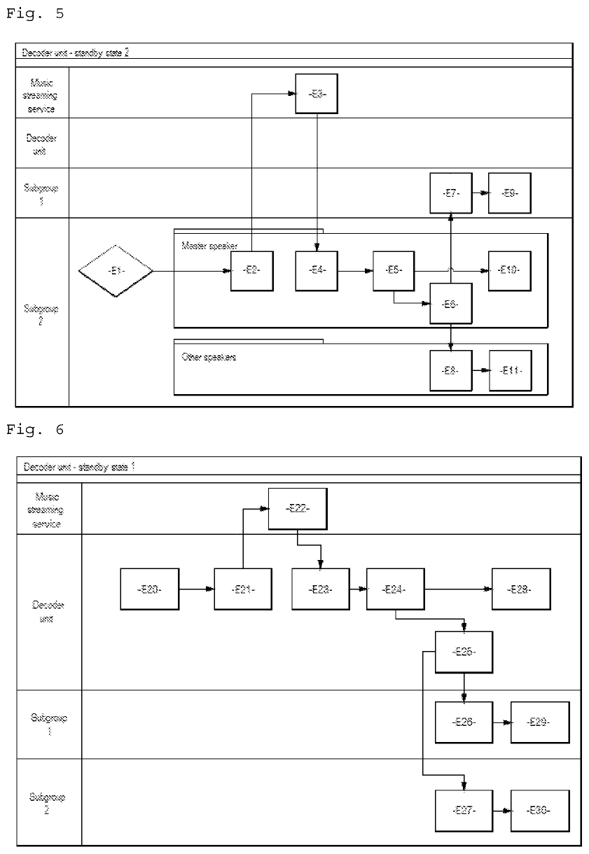

With reference to FIG. 6, consider the situation in which the audio/video decoder 3 is in the first standby state. The system is in the first mode, second submode.

The system begins by establishing the audio/video decoder 3 as the master (step E20). The audio/video decoder 3 requests audio data containing a music content from a music streaming service (step E21), and the service responds by sending the audio data (step E22).

The audio/video decoder 3 receives the audio data (step E23), decodes it, optionally proceeds with dematrixing the channels, followed optionally by rematrixing the channels (step E24), prior to sending the pertinent audio data to the various smart speakers 4 (step E25). The smart speakers 4a of the first subgroup 8a receive the audio data and decode it (step E26). Likewise, the smart speakers 4b of the second subgroup 8b receive the audio data and decode it (step E27). The internal speaker of the audio/video decoder (step E28), the smart speakers 4a of the first subgroup 8a (step E29), and the smart speakers 4b of the second subgroup 8b (step E30) then proceed with synchronized delivery of the music content.

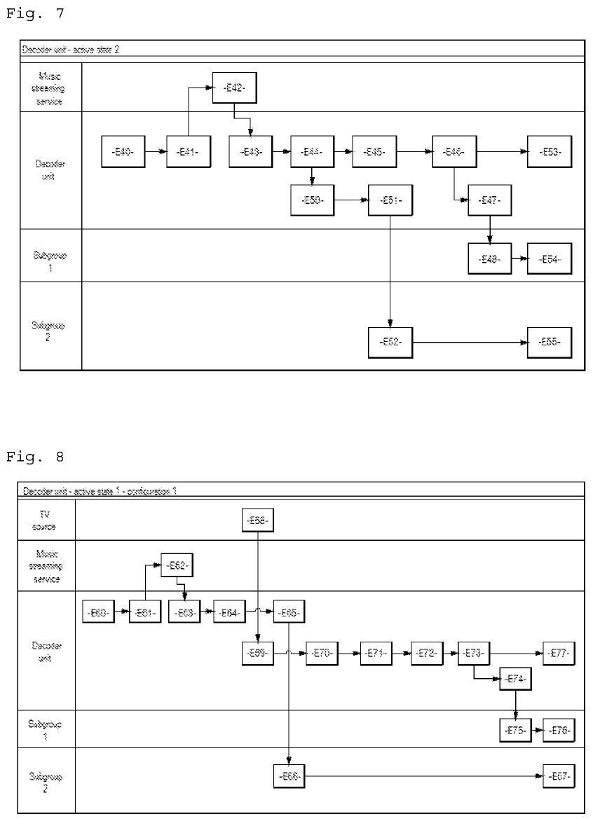

With reference to FIG. 7, consider the situation in which the audio/video decoder 3 is in the second active state. The system is in the first mode, first submode.

The system begins by establishing the audio/video decoder 3 as master (step E40), and requests audio data containing a music content from a music streaming service (step E41). The service responds by sending audio data (step E42).

The audio/video decoder 3 receives the audio data (step E43), decodes it, and optionally proceeds with dematrixing the channels (step E44). Two paths are then followed by the audio data, depending on destination.

In the first path, the audio data is mixed with the sounds associated with browsing in the graphical interface (step E45), and then possibly rematrixed (step E46). The data needed by the smart speakers 4a of the first subgroup 8a is then sent to those smart speakers 4a (step E47), which receive it (step E48).

In the second path, the audio data is optionally rematrixed (step E50), and then sent to the smart speakers 4b of the second subgroup 8b (step E51), which receive it (step E52).

Finally, the audio content is played back in synchronized manner by the internal speaker (step E53), by the smart speakers 4a of the first subgroup 8a (step E54), and by the smart speakers 4b of the second subgroup 8b (step E55). The internal speaker and the smart speakers 4a of the first subgroup 8a also play back the sounds of the graphical interface.

With reference to FIG. 8, the audio/video decoder 3 is in the first active state, and the system is thus in the second mode (first configuration). The user is viewing video content played back by the television set 5 and coming from an audio-video stream delivered by the audio/video decoder 3.

The system begins by establishing the audio/video decoder 3 as the master (step E60). The audio/video decoder 3 requests audio data containing a music content from the music streaming service (step E61), and the service responds by sending the audio data (step E62).

The audio/video decoder 3 receives the audio data (step E63), decodes it, and optionally proceeds with dematrixing and then rematrixing the channels (step E64), in order to match the signal to the configuration of the smart speakers. The audio data containing the music content is then sent to the smart speakers 4b of the second subgroup 8b (step E65), which receive it (step E66), prior to proceeding with synchronized delivery of the music content (step E67).

In parallel, a TV source sends the audio-video stream to the audio/video decoder 3 (step E68), which receives it (step E69). The TV source may be of various kinds: cable, satellite, DSL, VOD or IP streaming, local recording, etc.

The data of the audio-video stream is demultiplexed by the audio/video decoder 3, which extracts the audio stream therefrom (step E70), which stream is decoded and dematrixed (step E71) prior to being mixed with the sounds from the graphical interface, if any (step E72). The audio stream is then rematrixed (step E73), and then the pertinent channels are sent to the smart speakers 4a of the first subgroup 8a (step E74). These smart speakers 4a, together with the internal speaker of the audio/video decoder 3, receive the data (step E75) and play back the audio stream in synchronized manner (step E76).

In parallel, the video stream is also delivered by the audio/video decoder 3 and is played back in synchronized manner with the sound playback (step E77) (playback of the video stream is not shown, in order to simplify the diagram).

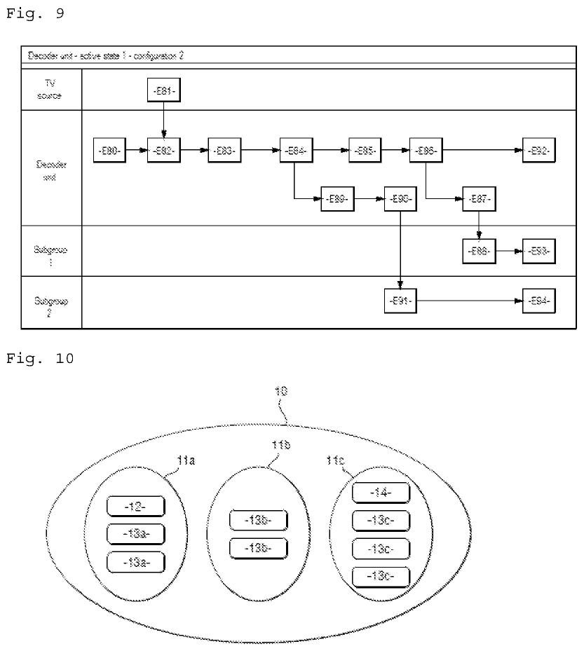

With reference to FIG. 9, the audio/video decoder 3 is in the first active state, and the system is thus in the second mode (second configuration). The user is viewing video content played back by the television set 5 and coming from an audio-video stream delivered by the audio/video decoder 3.

The system begins by establishing the audio/video decoder 3 as the master (step E80). A TV source sends the audio-video stream to the audio/video decoder 3 (step E81), which receives it (step E82).

The data of the audio-video stream is demultiplexed by the audio/video decoder 3, which extracts the audio stream therefrom (step E83), which stream is decoded and dematrixed (step E84) prior to being mixed with the sounds from the graphical interface, if any (step E85). The audio stream is then rematrixed (step E86), and then the pertinent channels are sent to the smart speakers 4a of the first subgroup 8a (step E87). The smart speakers 8a receive the data (step E88).

The audio data of the audio stream for the smart speakers 4b of the second subgroup 8b is rematrixed directly (step E89) without being mixed with the graphical interface sound, and is then sent to the smart speakers 4b (step E90), which receive this audio data (step E91).

The internal speaker of the audio/video decoder (step E92), the smart speakers 4a of the first subgroup 8a (step E93), and the smart speakers 4b of the second subgroup 8b (step E94) then play back the audio data in synchronized manner.

In all of these flowcharts, it would naturally be possible to arrange the functions in other ways while still achieving the same result for the user. For example, audio mixing could be performed equally well by the audio/video decoder 3 (or by the smart speakers 4a of the first subgroup 8a), without any difference being perceptible to the user. Likewise, the audio data coming from the music streaming service could optionally be obtained by a smart speaker 4 rather than by the audio/video decoder 3.

There follows a more particular description of the standby states of the equipment described above.

It frequently happens that a smart speaker has an automatic standby mode, which switches OFF its amplifier stages and possibly slows down the processor component, e.g. a DSP and/or an internal processor, of the smart speaker.

As mentioned above, the audio/video decoder 3 has a first standby state and a second standby state.

Several approaches are thus possible for handling the situation of an audio/video decoder 3 forming part of a multiroom group being on standby.

Provision may be made to prevent the audio/video decoder 3 from switching to the second standby state while the system is in the first mode and the common audio content (music content) is being played back.

It is also possible to prevent the audio/video decoder 3 switching to the second standby state whenever it forms part of a multiroom group. This may be an option, e.g. accessible in user settings.

A wake-on-LAN/wake-on-WAN (WoL/WoW) may enable a return from the second standby state to the first standby state in the event of network activity so as to enable the audio/video decoder 3 to become available once more for audio delivery. The WoL/WoW activity may be sent by some other element of the local network (smart speaker, controller, smartphone, etc.), when starting audio delivery (or a little sooner, e.g. when creating a playlist or when browsing in a music catalog).

There follows a consideration of the situation when a plurality of decoder units form part of the same multiroom group. It is then appropriate to create a subgroup for each audio/video decoder.

Thus, and with reference to FIG. 10, in the group 10, the first subgroup 11a, situated in a first room, comprises the audio/video decoder 12, its internal speaker (if any), and the smart speakers 13a. The second subgroup 11b, situated in a second room, comprises the smart speakers 13b. The third subgroup 11c, situated in a third room, comprises the audio/video decoder 14, its internal speaker (if any), and the connected speakers 13c.

When an audio/video decoder is in the (shallow) first standby state, its subgroup is considered as forming part of the subgroup of another room, and configuration is then managed in similar manner to managing configuration with only one audio/video decoder.

Nevertheless, when the system is configured in the second configuration (for the second mode), adjustments are needed since the entire group 10 cannot deliver simultaneously the audio stream of the audio-video stream delivered by the audio/video decoder 12 and the audio stream of the audio-video stream delivered by the audio/video decoder 14 (which streams, a priori, are different since a user watching television in the first room is likely to be watching a program that is different from the program being watched by a user in the third room).

Several approaches are possible.

A first approach consists in not allowing the system to be configured in the second mode (second configuration) whenever a plurality of decoder units form parts of the same multiroom audio group.

A second approach consists in not allowing a plurality of decoder units in the same multiroom audio group.

A third approach consists in managing the problem by defining priorities.

In a first priority option, the first audio/video decoder that delivers an audio-video stream triggers delivery of the audio stream via the smart speakers of the other rooms, and so long as this delivery continues it cannot be interrupted by another audio/video decoder. Management of the subgroup(s) including an audio/video decoder is unaffected.

In a second priority option, the audio/video decoder that starts delivery of the audio-video stream becomes the priority decoder for delivering the audio stream to the speakers in the other rooms, even if a preceding audio stream was already being delivered (initiated by the other audio/video decoder). Management of the subgroup(s) including an audio/video decoder is unaffected.

Naturally, the invention is not limited to the embodiment described, but covers any variant coming within the ambit of the invention as defined by the claims.

The first subgroup comprises the audio/video decoder and at least a first piece of audio playback equipment.

If the audio/video decoder incorporates an internal speaker, the first subgroup may comprise the internal speaker and one or more other first pieces of audio playback equipment, as described above for the smart speakers 4a. The internal speaker could also perfectly well be the only first piece of audio playback equipment in the first subgroup (which would then comprise solely the audio/video decoder incorporating the internal speaker).

In contrast, when the audio/video decoder does not include an internal speaker, the first subgroup includes at least one first piece of audio playback equipment that is a piece of equipment distinct from the audio/video decoder.

1. A sound playback method implemented in a system comprising an audio/video decoder connected to a television set and a plurality of pieces of audio playback equipment (4) that have been grouped together in the same audio group, the method comprising the steps of:
defining a first subgroup comprising the audio/video decoder and at least one first piece of audio playback equipment, and a second subgroup comprising at least one second piece of audio playback equipment;
as a function of at least one predefined parameter comprising a current operating state of the audio/video decoder, dynamically determining a current mode that is occupied by the system, from among a plurality of predefined modes comprising a first mode and a second mode;
when the system is in the first mode, in which the audio/video decoder is not delivering an audio-video stream, causing the first subgroup to play back a first audio signal comprising a common audio content, and causing the second subgroup to play back a second audio signal comprising the common audio content;
when the system is in the second mode, in which the audio/video decoder is delivering an audio-video stream, causing the first subgroup to play back a third audio signal comprising an audio stream forming part of the audio-video stream, and causing the second subgroup to play back a fourth audio signal.

2. The sound playback method according to claim 1, wherein the fourth audio signal does not comprise the audio stream forming part of the audio-video stream.

3. The sound playback method according to claim 1, wherein the fourth audio signal comprises the audio stream forming part of the audio-video stream.

4. The sound playback method according to claim 1, further comprising the step of determining that the system switches from the first mode to the second mode when the audio/video decoder switches from an operating state in which it is not delivering an audio-video stream to an operating state in which it is delivering an audio-video stream.

5. The sound playback method according to claim 1, wherein, when the system is in the first mode (or respectively in the second mode) and when a user is browsing in a graphical interface of the audio/video decoder visible on the television set, the first audio signal (or respectively the third audio signal) comprises sounds associated with browsing in said graphical interface, and the second audio signal (or respectively the fourth audio signal) does not comprise the sounds associated with browsing in said graphical interface.

6. The sound playback method according to claim 1, wherein the plurality of predefined modes also comprises a first submode and a second submode forming parts of the first mode, the system switching from the first submode to the second submode when the audio/video decoder switches from an active state in which the audio/video decoder can deliver a video content to a first standby state in which the audio/video decoder cannot deliver video content, and switches from the second submode to the first submode when the audio/video decoder switches from the first standby state to the active state.

7. The sound playback method according to claim 6, wherein the audio/video decoder includes an internal speaker that is in an ON state when the audio/video decoder is in the first standby state, and wherein the plurality of predefined modes also comprises a third submode forming part of the first mode, the system switching from the second submode to the third submode when the audio/video decoder switches from the first standby state to an OFF state or to a second standby state in which the internal speaker is in an OFF state, and switching from the third submode to the second submode when the audio/video decoder switches from the OFF state or from the second standby state to the first standby state.

8. The sound playback method according to claim 7, further comprising the step of preventing the audio/video decoder from switching to the second standby state while the system is in the first mode and the common audio content is being played back.

9. The sound playback method according to claim 7, wherein the plurality of predefined modes also comprises a third mode, the system switching from the third submode to the third mode when all of the second pieces of audio playback equipment switch to an OFF state, and from the third mode to the first mode when the audio/video decoder switches to an ON state and/or at least one of the second pieces of audio playback equipment switches to an ON state.

10. The sound playback method according to claim 1, comprising the step of not allowing the audio group to contain more than one audio/video decoder (3).

11. The system comprising an audio/video decoder and a plurality of pieces of audio playback equipment (4) grouped together in the same audio group, wherein the system implements the sound playback method according to claim 1.

12. The computer program including instructions that cause the system according to claim 11 to execute the steps of the sound playback method according to claim 1.

13. The computer-readable storage medium storing the computer program according to claim 12.

14. The master equipment forming part of a system comprising an audio/video decoder and a plurality of pieces of audio playback equipment grouped together in the same audio group, the master equipment being arranged to implement the sound playback method according to claim 1.

15. The master equipment according to claim 14, the master equipment being an audio/video decoder.

16. The master equipment according to claim 14, the master equipment being a smart speaker.

17. The computer program including instructions for causing the master equipment according to claim 14 to execute the steps of the sound playback method.

18. The computer-readable storage medium storing the computer program according to claim 17.
